(19) United States
(12) Patent Application Publication
(10) Pub. No.: US 2025/0233932 A1
(43) Pub. Date: Jul. 17, 2025

(54) MESSAGE SEGMENTED PARSING METHOD, APPARATUS, AND DEVICE, AND STORAGE MEDIUM

(71) Applicants: CHINA MOBILE (SUZHOU) SOFTWARE TECHNOLOGY CO., LTD., Suzhou, Jiangsu (CN); CHINA MOBILE COMMUNICATIONS GROUP CO., LTD., Beijing (CN)

(72) Inventors: Youling XIE, Suzhou (CN); Yiman HAN, Suzhou (CN); Shan JIANG, Suzhou (CN)

(21) Appl. No.: 18/703,752

(22) PCT Filed: Sep. 30, 2022
(86) PCT No.: PCT/CN2022/123455

§ 371 Date: Jun. 12, 2024

(30) Foreign Application Priority Data
Oct. 25, 2021 (CN) 202111242584.X

(51) Int. Cl. H04L 69/22

(52) U.S. Cl. CPC H04L 69/22

(57) ABSTRACT

The present disclosure relates to a message segmented parsing method, apparatus, and device, and a storage medium. In the present disclosure, an n-stage parsing result is obtained by, according to parsing configuration information, performing n-stage parsing on a header comprised in a message; when a next-level header type to be parsed that is comprised in the n-stage parsing result is not the header type of n+1-stage parsing, the n+1-stage parsing of the header is skipped and n+2-stage parsing is entered; when the next-level header type to be parsed is the header type of n+1-stage parsing, the header undergoes n+1-stage parsing according to the offset address of the next stage comprised in the n-stage parsing result; and when N-stage parsing is completed or previous N-1 layer protocol parsing determines to skip N-stage parsing, the current segmented parsing of the header is stopped.

### CROSS-REFERENCE TO RELATED APPLICATION

This application is filed based on and claims priority to a prior Chinese patent application No. 202111242584.X, filed on Oct. 25, 2021, the disclosure of which is hereby incorporated by reference in its entirety.

### TECHNICAL FIELD

The disclosure relates to, but is not limited to, the technical field of networks, in particular to a method and apparatus for a staged parsing of a message, a device and a storage medium.

### BACKGROUND

For a multi-layer network structure, different layers perform different functions, and each of the layers is composed of a number of protocols. Proper parsing of data packets is an important part of data transmission. Both data processing and data forwarding are required to parse the data packets to obtain corresponding header information of the data packets, such as a medium access control (MAC) address, an Internet protocol (IP), an IP address, etc.

At present, a mainstream method for parsing the data packets is to develop a specific parsing module based on a data type, in which a data format and data length are fixed, and if multiple types of data packets need to be processed, multiple parsing modules are required to be introduced. This type of parsing method has a low generality and is suitable for an application scenario with a low data complexity. In addition, this type of parsing method reduces a parsing speed of the system due to the fact that the data to be processed at each layer is a data message that contains all of the data, resulting in a longer length of data to be processed. Such type of method is not flexible for a communication system with different data packet transmission types, and a processing speed of the system for parsing may be greatly reduced.

### SUMMARY

Embodiments of the disclosure provide a method and apparatus for a staged parsing of a message, a device and a storage medium.

The solution of the disclosure is implemented as follows.

In a first aspect, there is provided a method for a staged parsing of a message. The message to be parsed includes a header, and the method includes the following operations.

An n-th stage of parsing of the header is performed based on parsing configuration information to obtain a parsing result in the n-th stage. When n is less than N, the parsing result in the n-th stage includes: header information parsed in the n-th stage, a header type of a next layer to be parsed in the message and an offset address for a next stage of parsing, N being a maximum number of parsing stages of the header.

An (n+1)-th stage of parsing of the header is skipped and an (n+2)-th stage of parsing is proceeded to when the header type of the next layer is not a header type to be parsed in the (n+1)-th stage.

The (n+1)-th stage of parsing of the header is performed based on the offset address when the header type of the next layer is the header type to be parsed in the (n+1)-th stage.

A staged parsing of the header is stopped when an N-th stage of parsing is completed or when a protocol parsing in an (N−1)-th layer determines that the N-th stage of parsing is to be skipped.

In a second aspect, there is provided an apparatus for a staged parsing of a message. The message to be parsed includes a header, and the apparatus includes a staged parsing module. The staged parsing module is configured to perform the following operations.

An n-th stage of parsing of the header is performed based on parsing configuration information to obtain a parsing result in the n-th stage. When n is less than N, the parsing result in the n-th stage includes: header information parsed in the n-th stage, a header type of a next layer to be parsed in the message and an offset address for a next stage of parsing, N being a maximum number of parsing stages of the header.

An (n+1)-th stage of parsing of the header is skipped and an (n+2)-th stage of parsing is proceeded to when the header type of the next layer is not a header type to be parsed in the (n+1)-th stage.

The (n+1)-th stage of parsing of the header is performed based on the offset address when the header type of the next layer is the header type to be parsed in the (n+1)-th stage.

A staged parsing of the header is stopped when an N-th stage of parsing is completed or when a protocol parsing in an (N−1)-th layer determines that the N-th stage of parsing is to be skipped.

In a third aspect, there is provided a computer device. The computer device includes a memory, a processor and a computer program stored on the memory and executable by the processor. The processor, when executing the program, performs the operations of the method for the staged parsing of the message in the first aspect.

In a fourth aspect, there is provided a computer-readable storage medium having stored thereon a computer program that, when being executed by a processor, causes the processor to perform the operations of the method for the staged parsing of the message in the first aspect.

In the method and apparatus for a staged parsing of a message, the device, and the storage medium provided by embodiments of the disclosure, the n-th stage of parsing of the header in the message is performed based on the parsing configuration information to obtain the parsing result in the n-th stage; the (n+1)-th stage of parsing of the header is skipped and the (n+2)-th stage of parsing is proceeded to when the header type of the next layer contained in the parsing result in the n-th stage is not the header type to be parsed in the (n+1)-th stage; the (n+1)-th stage of parsing of the header is performed based on the offset address for the next stage contained in the parsing result in the n-th stage, when the header type of the next layer to be parsed is the header type to be parsed in the (n+1)-th stage; and a staged parsing of the header is stopped when the N-th stage of parsing is completed or when the protocol parsing in the (N-1)-th layer determines that the N-th stage of parsing is to be skipped. In such a way, firstly, all the headers carried in the massage can be parsed regardless of in which stage the header can be parsed. Therefore, a generic parsing method can be used in various stages for the message carrying different types of headers. When a multi-type data packet is parsed in stages, there is no need to introduce multiple parsing modules, only one parsing module needs to be programmed, and parsing codes for all stages are the same. Therefore, the amount of parsing codes development can be reduced and generality can be improved. Secondly, the stage is skipped when the header corresponding to the stage is not carried, and a consumption of the unnecessary parsing stage of the header can be saved. Thirdly, the unnecessary parsing stage of the header is skipped, which can greatly improve the speed of data parsing.

It should be understood that the above general description and the below detailed description are exemplary and explanatory only and do not limit the embodiments of the disclosure.

### BRIEF DESCRIPTION OF THE DRAWINGS

FIG. 1 is a flowchart of a method for a staged parsing of a message provided by an embodiment of the disclosure.

FIG. 2 is another flowchart of a method for a staged parsing of a message provided by an embodiment of the disclosure.

FIG. 3 is yet another flowchart of a method for a staged parsing of a message provided by an embodiment of the disclosure.

FIG. 4 is still yet another flowchart of a method for a staged parsing of a message provided by an embodiment of the disclosure.

FIG. 5 is still yet another flowchart of a method for a staged parsing of a message provided by an embodiment of the disclosure.

FIG. 6 is a flowchart of a specific example of a method for a staged parsing of a message provided by an embodiment of the disclosure.

FIG. 7 is a schematic structure diagram of an apparatus for a staged parsing of a message provided by an embodiment of the disclosure.

FIG. 8 is a schematic diagram of a specific structure of a staged parsing module in the apparatus illustrated in FIG. 7.

FIG. 9 is a schematic structure diagram of a computer device provided by an embodiment of the disclosure.

### DETAILED DESCRIPTION

To make the purpose, technical solution, and advantages of the disclosure clearer, the technical solution in the embodiments of the disclosure will be described clearly and completely with reference to the accompanying drawings in the embodiments of the disclosure. It is apparent that the embodiments described herein are parts of the embodiments of the disclosure rather than all embodiments of disclosure. All other embodiments obtained by a person of ordinary skill in the art based on the embodiments of the disclosure without paying inventive efforts shall fall within the scope of protection of the disclosure. The embodiments and features in the embodiments in the disclosure may be combined with each other in any ways without conflict. The operations illustrated in the flowchart in the drawings may be performed in, for example, a computer system by executing a set of computer executable instructions. In addition, although logical orders are illustrated in the flowcharts, in some cases, the operations illustrated or described may be performed in a different order than that described herein.

It is understood that the description of the various embodiments in the disclosure emphasizes the difference between the various embodiments, the same or similar parts thereof may be referred to each other, and will not be elaborated in detail for the sake of brevity.

When data is transmitted in the network, a data packet includes a header and a body. When the data packet reaches its destination, the data header needs to be parsed because the data packet is processed and unpackaged in an order reverse to that corresponds to various protocol layers.

In mainstream data parsing methods, a parsing module with a fixed data format and a fixed data length is often chosen to parse header information of the data packet. For example, a respective parsing module is programmed based on a structure of each of an Ethernet header, an address resolution protocol (ARP) header, an Internet control message protocol (ICMP) header and other headers. This type of parsing method has a low generality and is suitable for an application scenario with a low data complexity.

In addition, a hierarchical parsing step is carried out on a data packet header corresponding to each layer protocol in a header field of the network data message in turn based on an order, from low to high, of the seven-layer structure of an open system interconnection, so that the purpose of generalization can be achieved. However, with the introduction of an overlay tunnel protocol such as a virtual extensible local area network (VXLAN), an virtual switching technology such as OpenFlow, Open vSwitch (OVS), and the 802.1Q-in-802.1Q (QinQ) technology, the complexity of a data plane in the network is increased sharply, and the complexity and difficulty of parsing are also increased. This kind of parsing method can no longer satisfy the data header parsing in these complex application scenarios. For example, the QinQ technology is based on the Ethernet protocol, and there will be multiple VLAN TAGs. This kind of parsing method cannot perform further parsing based on the protocol type.

In addition, in the above parsing method, the data to be processed has a large length in each stage because the data to be processed at each layer is a data message containing all of the data, which may reduce a parsing speed of a system. Such type of method is not flexible for a communication system with different data packet transmission types, and the processing speed of the system for parsing may be greatly reduced.

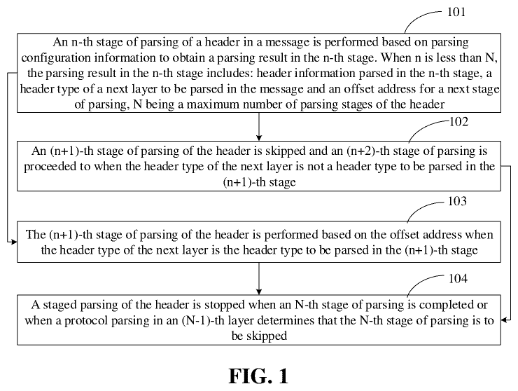

For this purpose, the embodiments of the disclosure provide a method for a staged parsing of a message. With reference to FIG. 1, the method for staged parsing of the message includes the following operations.

At operation 101, an n-th stage of parsing of a header in the message is performed based on parsing configuration information to obtain a parsing result in the n-th stage. When n is less than N, the parsing result in the n-th stage includes: header information parsed in the n-th stage, a header type of a next layer to be parsed in the message and an offset address for a next stage of parsing, N being a maximum number of parsing stages of the header.

The n-th stage is used for parsing a protocol header at the n-th layer in a layered network architecture. The message may be parsed in stages from outside to inside based on the layered network architecture. Multiple protocol headers may be parsed in each stage. The layering of the layered network architecture includes a seven-layer model for an open system interconnect (OSI) and a four-layer model for a transmission control protocol/Internet protocol (TCP/IP).

The respective parsing configuration information is pre-configured for each stage, and the parsing configuration information is also called preset stage information. The parsing configuration information for each stage is stored in a preset stage information table. The parsing configuration information for the n-th stage is configured to perform the n-th stage of parsing of the header in the message to obtain the parsing result in the n-th stage.

The header type of the next layer is a protocol type of a header of a next layer. Herein, it should be noted that the header type of the next layer to be parsed in the message included in the parsing result in the n-th stage is a header type of any of the (n+1)-th layer to the N-th layer in the message. For example, when the header type of the next layer is a header type that can be parsed in the (n+2)-th layer, the message will not be processed after proceeding to the (n+1)-th stage, and will directly flow to the (n+2)-th stage for parsing.

The offset address for the next stage is a header offset for the next stage, which points to a starting position of the protocol header in the next layer in the data packet.

It is to be understood that, in addition to the header type of the next layer to be parsed in the message and the offset address for the next stage of parsing, the parsing result in n-th stage further includes the header information in the n-th layer and key information, for example, the key information for the Ethernet header includes a source MAC address and a destination MAC address, and the like.

It should be noted that when a stage of parsing is completed, the parsing result in this stage, such as the obtained header information and key information, is stored in a corresponding location, and then the parsing proceeds to the next stage.

At operation 102, an (n+1)-th stage of parsing of the header is skipped and an (n+2)-th stage of parsing is proceeded to when the header type of the next layer is not a header type to be parsed in the (n+1)-th stage.

In some examples, it is determined that the header type of the next layer is not the header type to be parsed in the (n+1)-th stage when the header type of the next layer is not included in the preset stage information for the (n+1)-th stage.

At operation 103, the (n+1)-th stage of parsing of the header is performed based on the offset address when the header type of the next layer is the header type to be parsed in the (n+1)-th stage.

In some examples, it is determined that the header type of the next layer is the header type to be parsed in the (n+1)-th stage when the header type of the next layer is included in the preset information table for the (n+1)-th stage.

At operation 104, a staged parsing of the header is stopped when an N-th stage of parsing is completed or when a protocol parsing in an (N−1)-th layer determines that the N-th stage of parsing is to be skipped.

In the method for the staged parsing of the message provided by the embodiment of the disclosure, the (n+1)-th stage of parsing of the header is skipped and the (n+2)-th stage of parsing is proceeded to when the parsing result of the header in the n-th stage includes the header type of the next layer that is not the header type to be parsed in the (n+1)-th stage.

A stage of parsing in the embodiments of the disclosure may correspond to the parsing of a protocol layer in network transmission of the data packet.

The message may contain up to 4 layers of protocols when the message is transmitted based on the TCP/IP protocol, namely, an application layer protocol, a transport layer protocol, a network layer protocol and a data link layer protocol. In this case, N may be equal to 4, i.e., one stage corresponds to the parsing of the header of one layer.

A layer may include many different protocols, and different header types may be carried in the header. For example, the header types corresponding to the transport layer may include, but are not limited to, a TCP header and a user datagram protocol (UDP) header. For example, the header types corresponding to the network layer may include, but are not limited to, an Internet control message protocol (ICMP) header, an address resolution protocol (ARP) header, and a reverse address resolution protocol (RARP) header.

The (n+1)-th stage of parsing of the header is performed based on the offset address for the next stage contained in the parsing result in the n-th stage when the header type of the next layer to be parsed is the header type to be parsed in the (n+1)-th stage. A staged parsing of the header is stopped when the N-th stage of parsing is completed or when the protocol parsing in the (N−1)-th layer determines that the N-th stage of parsing is to be skipped. In such a way, all the headers carried in the massage can be parsed regardless of in which stage the header can be parsed. Therefore, a generic parsing method can be used in various stages for parsing the message that carries different types of headers. When a multi-type data packet is parsed in stages, there is no need to introduce multiple parsing modules, only one parsing module needs to be programmed, and parsing codes for all stages are the same. Therefore, the amount of code development can be reduced, generality can be improved, the generic data parsing is implemented and logical resources of the system can be greatly saved. In addition, since there is no need to process all data contained in the message at each stage, the parsing speed of the data message can be greatly improved.

In an embodiment, the parsing configuration information includes field parsing information and stage transition information.

The parsing configuration information for the n-th stage includes the field parsing information and the stage transition information for the n-th stage.

The field parsing information for the n-th stage includes: a header type that can be parsed in the n-th stage and a header field corresponding to each header type.

The stage transition information includes the header type of the next layer to be parsed in the message and the offset address for the next phase. The stage transition information has a correspondence with the header field.

It is to be understood that the parsing configuration information may also include other configuration information such as a header structure.

In the embodiment, the header type, the header field corresponding to each header type and a stage transition information table included in the parsing configuration information for each stage may be encapsulated into a function, so that the user may call an upper software to modify the header type to be parsed and the number of stages for parsing based on the application scenario, which makes the information configurable, and facilitates upgrading and iteration to satisfy the message parsing requirements in different applications.

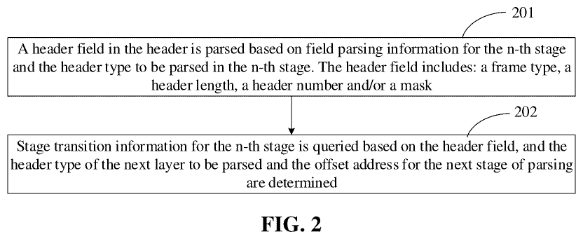

As illustrated in FIG. 2, the operation 101 that the n-th stage of parsing of the header is performed based on the parsing configuration information to obtain the parsing result in the n-th stage may include the following operations.

At operation 201, a header field in the header is parsed based on the field parsing information for the n-th stage and a header type to be parsed in the n-th stage. The header field includes: a frame type, a header length, a header number and/or a mask.

The network transmits data on a frame-by-frame basis, different frame types indicate specific formats of different protocol types used for transmitting data over the network, and different frame types have different offsets.

The header length is a protocol length, for example, the length of the Ethernet header is 14 bytes, and the length of the Internet protocol version 4 (IPv4) header is 20 bytes. The header number is used for uniquely identifying the header type.

The mask indicates bits that need to be reserved and/or bits that need to be cleared in the header field.

It is to be understood that in practical applications, only the frame type and the mask may be included in the header field.

In an example, preset header fields corresponding to different header types are stored in a preset header field table, which may be illustrated in Table 1 below.

TABLE 1
Preset header field table

| Header | Frame | | | Frame | |
|---|---|---|---|---|---|
| type | type [0] | Mask [0] | . . . | type [n] | Mask [n] |
| Header | Field [0] [0] | Mask [0] [0] | . . . | Field [0] [0] | Mask [0] [0] |
| type 0 | . . . | . . . | . . . | . . . | . . . |
| | Field [0] [n] | Mask [0] [n] | . . . | Field [0] [n] | Mask [0] [n] |
| . . . | . . . | . . . | . . . | . . . | . . . |
| Header | Field [n] [0] | Mask [n] [0] | . . . | Field [n] [0] | Mask [n] [0] |
| type n | . . . | . . . | . . . | . . . | . . . |
| | Field [n] [n] | Mask [n] [n] | . . . | Field [n] [n] | Mask [n] [n] |

The header field table illustrated in Table 1 includes the frame type that each protocol type may contain. In this way, for the application scenario of the QinQ technology in which a two-layer tunneling protocol with two VLAN Tags is included in the message, multiple frame types may be set in the header field for each protocol type, and different frame types have different offsets.

In the embodiment, because the preset header field includes the frame types that may be included in different protocol types, multiple frame type fields may be set in the preset header field based on the characteristic of multiple VLAN TAGs in QinQ, to obtain respective VLAN headers. Therefore, the parsing of data type can be more refined by using the frame types, so that subsequent parsing can be performed more accurately, and the parsing of the data header in complex application scenarios using technologies such as QinQ can be satisfied.

In some examples, at the operation 201, the header is parsed based on the header field corresponding to each header type in the field parsing information for the n-th stage, to obtain the header field corresponding to the header type to be parsed.

At operation 202, the stage transition information for the n-th stage is queried based on the header field, and the header type of the next layer to be parsed and the offset address for the next stage of parsing are determined.

In an example, the stage transition information for various stages is stored in a preset stage transition information table. The preset stage transition information table may be illustrated in Table 2 below, but is not limited thereto.

TABLE 2
Preset stage transition information table

| | Action | Next layer | Offset address |
|---|---|---|---|
| Header type | flag bit | header type | for next stage |
| Header type 0 | 0/1 | Header type | Header offset |
| | . . . | . . . | . . . |
| | 0/1 | Header type | Header offset |
| . . . | . . . | . . . | . . . |
| Header type n | 0/1 | Header type | Header offset |
| | . . . | . . . | . . . |
| | 0/1 | Header type | Header offset |

As illustrated in Table 2, the stage transition information table includes the header type of the next layer with different header type, the offset address for the next stage, and may also include the action flag bit indicating whether the parsing of a current data segment has been completed. The action flag bit of 1 indicates that the parsing of the current data segment has been completed, and the action flag bit of 0 indicates that the parsing of the current data segment has not been completed. In this way, the stage transition information corresponding to a header field may be queried in the preset stage transition information table after obtaining the header field, to obtain the header type of the next layer to be parsed, the offset address for the next stage and the action flag bit indicating whether the parsing of the current data segment has been completed.

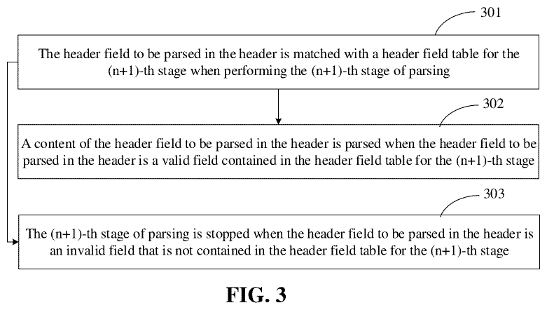

In an embodiment, as illustrated in FIG. 3, the operation 103 that the (n+1)-th stage of parsing of the header is performed based on the offset address may include the following operations.

At operation 301, the header field to be parsed in the header is matched with a header field table for the (n+1)-th stage when performing the (n+1)-th stage of parsing.

At operation 302, a content of the header field to be parsed in the header is parsed when the header field to be parsed in the header is a valid field contained in the header field table for the (n+1)-th stage.

In the embodiment, the header field to be parsed in the header may be compared with a preset header field table when performing the (n+1)-th stage of parsing, to determine whether the header field to be parsed is consistent with a field in a certain row in the header field table. If yes, the header field to be parsed is determined to be a valid field; otherwise, the header field to be parsed is determined to be an invalid field. The header is continued to be parsed to obtain the content of the header field when the header field to be parsed in the header is a valid field.

In an embodiment, continuing to refer to FIG. 3, the method may further include the following operation.

At operation 303, the (n+1)-th stage of parsing is stopped when the header field to be parsed in the header is an invalid field that is not contained in the header field table for the (n+1)-th stage.

In the embodiment, when the header field to be parsed in the header is determined to be an invalid field, the (n+1)-th stage of parsing is stopped, and the method proceeds to the (n+2)-th stage for determination.

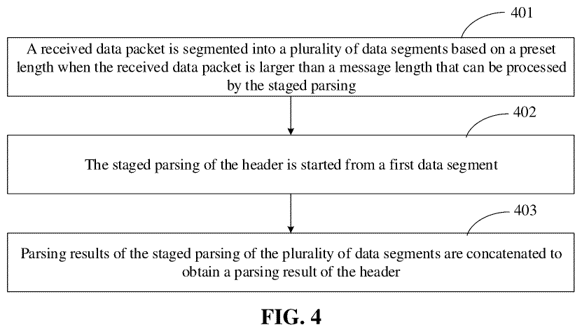

In an embodiment, with reference to FIG. 4, the method may further include the following operations.

At operation 401, a received data packet is segmented into a plurality of data segments based on a preset length when the received data packet is larger than a message length that can be processed by the staged parsing.

The message length that can be processed may be the largest length among header lengths corresponding to different header types. Herein, the message length that can be processed may be set as 64 bytes, but the embodiments of the disclosure are not limited thereto.

Herein, the preset length may be set according to the actual applications, for example, the preset length may be set to the same length as the message length that can be processed.

At operation 402, the staged parsing of the header is started from a first data segment.

In some examples, the operations 101 to 104 for the staged parsing of the header are started from the first data segment, and the staged parsing of the header is continued for the second data segment when the parsing of the first data segment is completed, and so on, until the parsing of the headers of all data segments are completed.

At operation 403, parsing results of the staged parsing of the plurality of data segments are concatenated to obtain a parsing result of the header.

In some examples, the parsing result of the staged parsing of each data segment may be concatenated when all the data segments of the data packet have been parsed in stages in turn, to obtain the parsing result of the header of the data packet finally.

In the embodiment of the disclosure, the data packet is segmented into a plurality of data segments with a fixed length based on the message length that can be processed by the staged parsing, and each of the data segments is parsed in stages in turn, so that a complex data packet with an indefinite protocol length can be dealt with, and the speed of data parsing can be further accelerated.

In an embodiment, the operation 103 that the (n+1)-th stage of parsing of the header is performed based on the offset address when the header type of the next layer is the header type to be parsed in the (n+1)-th stage may include the following operation.

When the (n+1)-th stage of parsing is performed on a current data segment, in response to determining that a field to be parsed is partially located in a next data segment based on the offset address for parsing in the next stage, a header length corresponding to the header type of the next layer and a parsing length indicated by the field parsing information for the (n+1)-th stage, the (n+1)-th stage of parsing is performed based on the current data segment in combination with the next data segment.

In some examples, when the (n+1)-th stage of parsing is performed on the current data segment, whether the field to be parsed is partially located in the next data segment is determined based on whether a sum of the header length corresponding to the header type of the next layer and a header offset is larger than the parsing length indicated by the field parsing information for the (n+1)-th stage. The header to be parsed is determined to span both the current data segment and the next data segment when the field to be parsed is partially located in the next data segment.

When the sum of the header length corresponding to the header type of the next layer and the header offset is larger than the parsing length indicated by the field parsing information for the (n+1)-th stage, the field to be parsed is determined to be partially located in the next data segment. That is, the header information to be parsed is determined to be segmented into the current data segment and the next data segment.

When the sum of the header length corresponding to the header type of the next layer and the header offset is smaller than or equal to the parsing length indicated by the field parsing information for the (n+1)-th stage, the field to be parsed is determined to be located in whole in the next data segment.

Due to the data segmentation, the header to be parsed in one stage may be located in different data segments, and the parsing of the header in this stage may be performed cross segments.

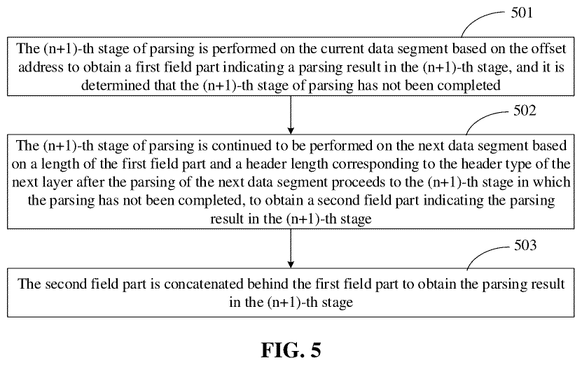

In an embodiment, as illustrated in FIG. 5, the operation that the (n+1)-th stage of parsing is performed based on the current data segment in combination with the next data segment may include the following operations.

At operation 501, the (n+1)-th stage of parsing is performed on the current data segment based on the offset address to obtain a first field part indicating a parsing result in the (n+1)-th stage, and it is determined that the (n+1)-th stage of parsing has not been completed.

At operation 502, the (n+1)-th stage of parsing is continued to be performed on the next data segment based on a length of the first field part and the header length corresponding to the header type of the next layer, after the parsing of the next data segment proceeds to the (n+1)-th stage in which the parsing has not been completed, to obtain a second field part indicating the parsing result in the (n+1)-th stage.

In some examples, the (n+1)-th stage of parsing is continued to be performed on the next data segment based on a difference between the header length corresponding to the header type of the next layer and the length of the first field part, to obtain the second field part.

At operation 503, the second field part is concatenated behind the first field part to obtain the parsing result in the (n+1)-th stage.

In some examples, the first field part is shifted to the left, the second field part is shifted to the right, and the second field part after being shifted to the right is concatenated behind the first field part after being shifted to the left, to obtain a complete parsing result of the header.

In the embodiment, because the header information to be parsed is segmented into the current data segment and the next data segment, the first field part is obtained by performing the (n+1)-th stage of parsing on the current data segment, and then the (n+1)-th stage of parsing is performed on the next data segment after the next data segment proceeds to the (n+1)-th stage in which the parsing has not been completed, to obtain the second field part. The second field part is then concatenated behind the first field part, so that the complete parsing result in the (n+1)-th stage can be obtained.

In an embodiment, the operation 103 that the (n+1)-th stage of parsing of the header is performed based on the offset address when the header type of the next layer is the header type to be parsed in the (n+1)-th stage may include the following operation.

When the (n+1)-th stage of parsing is performed on a current data segment, in response to determining that a field to be parsed is entirely located in the current data segment based on the offset address for the next stage of parsing, a header length corresponding to the header type of the next layer and a parsing length indicated by the field parsing information for the (n+1)-th stage, the (n+1)-th stage of parsing is performed on the current data segment to obtain a parsing result in the (n+1)-th stage.

In the embodiment, when the field to be parsed is determined to be entirely located in the current data segment, the (n+1)-th stage of parsing is performed only on the current data segment to obtain the complete parsing result in the (n+1)-th stage.

Accordingly, in the embodiment of the disclosure, after the data packet is segmented, the header may be cut. A length after offset is obtained by adding the header length corresponding to the next layer header length type to be parsed and the header offset. If the length of the header after offset is greater than the length of the data segment, it is determined that the header at this stage spans two data segments, and the header needs to be extracted in combination with the next data segment. If the header does not span different data segments, the header is directly extracted from the current data segment based on the header offset.

The method for the staged parsing of the message provided by the embodiment of the disclosure will be illustrated in the following in combination with specific examples.

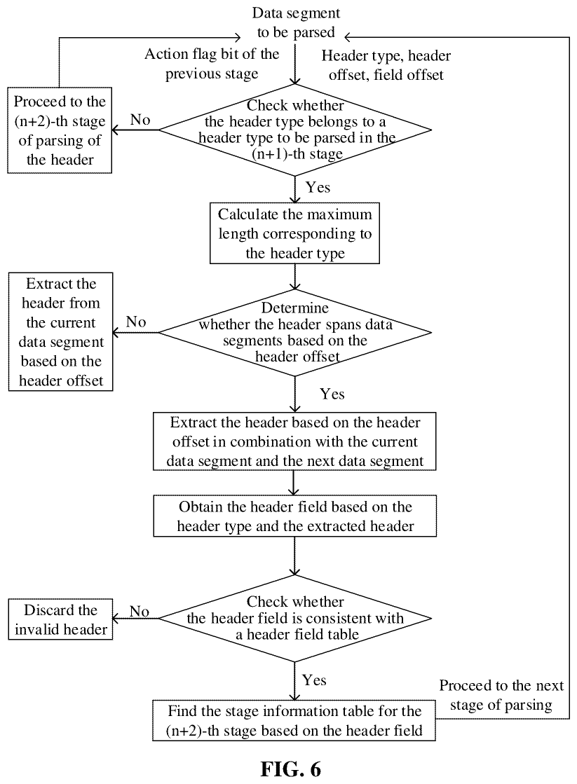

As illustrated in FIG. 6, FIG. 6 is a flowchart of a specific example of a method for a staged parsing of a message provided by an embodiment of the disclosure. The method may include the following operations.

1. A next layer header type to be parsed, a header offset and a flag bit indicating whether a stage of parsing has been completed are obtained from a parsing result in the n-th stage when performing the (n+1)-th stage of parsing on a current data segment.

If the flag bit of the n-th stage indicates that the n-th stage of parsing has been completed, that is, an operation in the n-th stage is Prev_Stg_Done, then the (n+1)-th stage of parsing needs to be started. If the operation in the n-th stage is Wait, in such case, the (n+1)-th stage needs to wait. Alternatively, if the operation in the n-th stage is No Operation (NOP), then nothing is to be done in the (n+1)-th stage, and the packet is sent only without any parsing.

2. Whether the header type belongs to a header type to be parsed in the (n+1)-th stage is checked. If yes, operation 3 is carried out; if no, the (n+2)-th stage of parsing of the header is carried out.

Multiple header types that can be parsed may be preset in each stage, and numbers may also be set for the header types. Whether the parsing operation is carried out in the (n+1)-th stage may be determined by checking whether the number of the header type corresponds to header type to be parsed in the (n+1)-th stage. If the number does not correspond to the header type to be parsed in the (n+1)-th stage, the operation may flow to the next stage without processing.

3. A header length corresponding to the header type is calculated.

The header length corresponding to each header type is preset, and the header length corresponding to the header type is obtained based on the inputted header type.

4. It is determined whether the header type spans different data segments based on the header length corresponding to the header type in combination with a header offset. If yes, operation 5 is performed; if no, operation 6 is performed.

5. The header is extracted based on the header offset in combination with the current data segment and the next data segment.

6. The header is extracted from the current data segment based on the header offset.

7. A header field is obtained based on the header type and the extracted header.

8. Whether the header field is consistent with a preset header field table is checked; if yes, operation 9 is executed; if no, the invalid header is discarded.

9. Stage information table for the (n+2)-th stage corresponding to the header field is found based on the header field.

After a valid header field is obtained, the corresponding stage transition information table is queried, to obtain the header type for the next stage, the header offset and the flag bit indicating whether the parsing of the current data segment has been completed.

The method for a staged parsing of a message provided by an embodiment of the disclosure will continue to be illustrated in the following in combination with specific examples.

Assuming that a length of data to be parsed in each stage is 64 bytes and a data packet traversing the Ethernet protocol layer, IPv4 protocol layer and TCP protocol layer is taken as an example, the data packet is parsed layer by layer from the outside to the inside. The Ethernet layer may pass through the Ethernet only, and may also traverse one VLAN or two VLANs. The network layer may include ARP protocol, IPv4 protocol and an Internet protocol version 6 (IPv6) protocol, and the transport layer may include ICMP protocol, UDP protocol, TCP protocol and a Generic Routing Encapsulation (GRE) protocol. There is different parsing configuration information for these protocols in the preset stage information table. The purpose of parsing of the Ethernet layer is to obtain a source MAC address and a destination MAC address; the purpose of parsing of the network layer header is to obtain a source IP address and a destination IP address; and the purpose of parsing of the transport layer header is to obtain a source port number and a destination port number.

1. First stage of parsing of the header

The data packet is parsed in the first stage, and the header type input to the first stage is initialized as Ethernet, with the header offset of 0 and the flag bit, indicating whether a previous stage of parsing has been completed, of 1. Specifically, the content in the preset stage information table corresponding to the Ethernet protocol contained in the data packet is shown in Table 3 below.

TABLE 3
Preset stage information for the first stage

| | Header | Header | | Header | Stage transition |
|---|---|---|---|---|---|
| Stage | type | length | Number | field table | information table |
| First | Ethernet | 14 | 0 | As illustrated | As illustrated |
| stage | | | | in Table 4 | in Table 5 |

TABLE 4
Header field for Ethernet header

| Header | Frame | Mask | Frame | Mask | Frame | Mask |
|---|---|---|---|---|---|---|
| type | type [0] | [0] | type [0] | [0] | type [0] | [0] |
| Ethernet | Ethernet0 | 16′hffff | 0 | 0 | 0 | 0 |

TABLE 5
Stage transition information for Ethernet header

| | | Header type | Header offset |
|---|---|---|---|
| Header type | Action flag bit | for next stage | for next stage |
| Ethernet | 1 | IPv4 | 14 |

The header structure of the Ethernet header is illustrated in Table 6 below.

TABLE 6
Preset structure of Ethernet header

| | | | | | | | |
|---|---|---|---|---|---|---|---|
| Ethernet | Source | Destina- | Ethernet | Vlana | Vlana | Vlanb | Vlanb |
| header | MAC | tion | type | related | type | related | type |
| | address | MAC | | Field | | Field | |
| | | address | | | | | |

The Ethernet header of the data packet is obtained after the first stage of parsing of the header, and then the corresponding Ethernet frame type, source MAC address and destination MAC address are obtained based on the structure of the Ethernet header. It is determined that the header does not span the data segments based on the fact that the sum of the header offset of 0 byte and the length of the Ethernet header is 14 bytes, which is less than the data packet length of 64 bytes. Therefore, the action flag bit of the first stage is set as 1 after the parsing of the Ethernet header has been completed. The header type input to the next stage is set as IPv4, the header offset is 14 and the flag bit indicating whether the previous stage of parsing has been completed is 1.

2. Second stage of parsing of the header

IP header will be parsed in the second stage, and the content in the preset stage information table corresponding to the IP protocol contained in the data packet is shown in Table 7 below.

TABLE 7
Preset stage information for the second stage

| | Header | Header | | Header | Stage transition |
|---|---|---|---|---|---|
| Stage | type | length | Number | field table | information table |
| Second | IPv4 | 20 | 1 | As illustrated | As illustrated |
| stage | | | | in Table 8 | in Table 9 |

TABLE 8
Header field for IPv4 header

| Header | Frame | Mask | Frame | Mask | Frame | Mask |
|---|---|---|---|---|---|---|
| Type | type [0] | [0] | type [0] | [0] | type [0] | [0] |
| IPv4 | IPv40 | 16′h00ff | 0 | 0 | 0 | 0 |

TABLE 9
Stage transition information for IPV4 header

| | | Header type | Header offset |
|---|---|---|---|
| Header type | Action flag bit | for next layer | for next stage |
| IPv4 | 1 | TCP | 34 |

The header structure of the IPV4 header is illustrated in Table 10 below.

TABLE 10
Preset structure of IPv4 header

| | | | | | | | | | | |
|---|---|---|---|---|---|---|---|---|---|---|
| Version | Header | Priority | Congestion | Total | Identification | Flag | Life | Protocol | Source | Destination |
| number | length | | notification | length | | | cycle | verification | IP | IP |
| | | | | | | | | | address | address |

The IPv4 header of the data packet is obtained after the second stage of parsing of the header, and then the corresponding key information including a source IP address and destination IP address is obtained based on the structure of the IPV4 header. It is determined that the header does not span the data segments based on the fact that the sum of the header offset of 14 byte and the length of the IPV4 header is 34 bytes, which is less than the data packet length of 64 bytes. Therefore, the action flag bit of the second stage is set as 1 after the parsing of the IPv4 header has been completed. The header type input to the next stage is set as TCP, the header offset is 34 and the flag bit indicating whether the previous stage of parsing has been completed is 1.

3. Third stage of parsing of the header

TCP header will be parsed in the third stage, and the content in the preset stage information table corresponding to the TCP protocol contained in the data packet is shown in Table 11 below.

TABLE 11
Preset stage information for the third stage

| Header | Header | | | Stage transition |
|---|---|---|---|---|
| type | length | Number | Header field | information table |
| TCP | 20 | 5 | As illustrated | As illustrated |
| | | | in Table 12 | in Table 13 |

TABLE 12
Header field for TCP header

| Header | Frame | Mask | Frame | Mask | Frame | Mask |
|---|---|---|---|---|---|---|
| type | type [0] | [0] | type [0] | [0] | type [0] | [0] |
| TCP | 0 | 0 | 0 | 0 | 0 | 0 |

Note: The header in the TCP header type has no frame type.

TABLE 13
Stage transition information for TCP header

| | | Header type | Header offset |
|---|---|---|---|
| Header type | Action flag bit | for next layer | for next stage |
| TCP | 1 | Load | 54 |

The preset structure of the TCP header is illustrated in Table 14.

TABLE 14
Preset structure of TCP header

| | | | | | | | | |
|---|---|---|---|---|---|---|---|---|
| Source port | Destination | Serial | Confirmation | Offset | Flag | Sliding | Check | Emergency |
| number | port number | number | number | | | window | sum | mode |

The TCP header of the data packet is obtained after the third stage of parsing of the header, and then the corresponding key information including a source port number and destination port number is obtained based on the structure of the TCP header. It is determined that the header does not span the data segments based on the fact that the sum of the header offset of 34 bytes and the length of the TCP header is 54 bytes, which is less than the data packet length of 64 bytes. Therefore, the action flag bit of the current stage is set as 1 after the parsing of the TCP header has been completed. The header type input to the next stage is set as Load, the header offset is 54 and the flag bit indicating whether the previous stage of parsing has been completed is 1.

When parsing is performed to the load part, the header of the message will no longer be parsed, and the data will transfer directly to the next stage until the last stage. After the staged parsing of the data packet, the corresponding Ethernet header, IPv4 header and TCP header are obtained, and the key information including the source MAC address and the destination MAC address, the source IP address and the destination IP address, the source port number and the destination port number is obtained, which is convenient for subsequent data forwarding and processing.

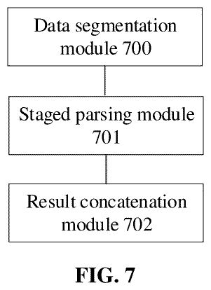

In an embodiment, there is provided an apparatus for a staged parsing of a message. The message to be parsed includes a header. As illustrated in FIG. 7, the apparatus includes a staged parsing module 701. The staged parsing module 701 is configured to perform the following operations.

An n-th stage of parsing of the header is performed based on parsing configuration information to obtain a parsing result in the n-th stage. When n is less than N, the parsing result in the n-th stage includes: header information parsed in the n-th stage, a header type of a next layer to be parsed in the message and an offset address for a next stage of parsing, N being a maximum number of parsing stages of the header.

An (n+1)-th stage of parsing of the header is skipped and an (n+2)-th stage of parsing is proceeded to when the header type of the next layer is not a header type to be parsed in the (n+1)-th stage.

The (n+1)-th stage of parsing of the header is performed based on the offset address when the header type of the next layer is the header type to be parsed in the (n+1)-th stage.

A staged parsing of the header is stopped when an N-th stage of parsing is completed or when a protocol parsing in an (N−1)-th layer determines that the N-th stage of parsing is to be skipped.

In an embodiment, the parsing configuration information includes field parsing information and stage transition information.

The staged parsing module 701 is configured to parse a header field in the header based on the field parsing information for the n-th stage and a header type to be parsed in the n-th stage. The header field includes: a frame type, a header length, a header number and/or a mask.

The staged parsing module 701 is further configured to query the stage transition information for the n-th stage based on the header field, to determine the header type of the next layer to be parsed and the offset address for the next stage of parsing.

In an embodiment, the staged parsing module 701 is configured to perform the following operations.

The header field to be parsed in the header is matched with a header field table for the (n+1)-th stage when performing the (n+1)-th stage of parsing.

A content of the header field to be parsed in the header is parsed when the header field to be parsed in the header is a valid field contained in the header field table for the (n+1)-th stage.

In an embodiment, the staged parsing module 701 is further configured to perform the following operation.

The (n+1)-th stage of parsing is stopped when the header field to be parsed in the header is an invalid field that is not contained in the header field table for the (n+1)-th stage.

In an embodiment, the apparatus further includes a data segmentation module 700 and a result concatenation module 702.

The data segmentation module 700 is configured to segment a received data packet into a plurality of data segments based on a preset length when the received data packet is larger than a message length that can be processed by the staged parsing.

The staged parsing module 701 is configured to start the staged parsing of the header from a first data segment.

The result concatenation module 702 is configured to concatenate parsing results of the staged parsing of the plurality of data segments to obtain a parsing result of the header.

In an embodiment, the staged parsing module 701 is configured to: when the (n+1)-th stage of parsing is performed on a current data segment, in response to determining that a field to be parsed is partially located in a next data segment based on the offset address for parsing in the next stage, a header length corresponding to the header type of the next layer and a parsing length indicated by the field parsing information for the (n+1)-th stage, perform the (n+1)-th stage of parsing based on the current data segment in combination with the next data segment.

In an embodiment, the staged parsing module 701 is configured to: perform the (n+1)-th stage of parsing on the current data segment based on the offset address to obtain a first field part indicating a parsing result in the (n+1)-th stage, and determine that the (n+1)-th stage of parsing has not been completed; continue to perform the (n+1)-th stage of parsing on the next data segment based on a length of the first field part and the header length corresponding to the header type of the next layer after the parsing of the next data segment proceeds to the (n+1)-th stage in which the parsing has not been completed, to obtain a second field part indicating the parsing result in the (n+1)-th stage; and concatenate the second field part behind the first field part to obtain the parsing result in the (n+1)-th stage.

In an embodiment, the staged parsing module 701 is configured to: when the (n+1)-th stage of parsing is performed on a current data segment, in response to determining that a field to be parsed is entirely located in the current data segment based on the offset address for the next stage of parsing, a header length corresponding to the header type of the next layer and a parsing length indicated by the field parsing information for the (n+1)-th stage, perform the (n+1)-th stage of parsing on the current data segment to obtain a parsing result in the (n+1)-th stage.

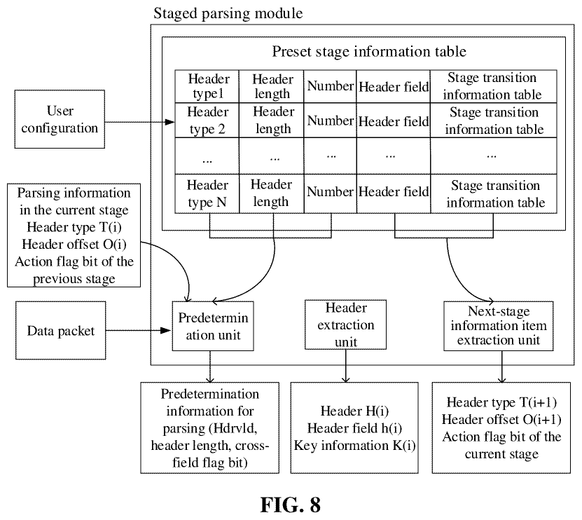

The staged parsing module in the apparatus for the staged parsing of the message provided by the embodiment of the disclosure will be further illustrated below with reference to FIG. 8.

As illustrated in FIG. 8, the staged parsing module includes a predetermination unit, a header extraction unit, and a next-stage information item extraction unit.

The predetermination unit is configured to determine whether a header type needs to be parsed based on a header type, a header offset and a flag bit indicating a parsing in a previous stage has been completed included in an inputted parsing information for the current stage, in combination with preset stage information corresponding to the current stage in a preset stage information table; determine a header length corresponding to the header type that needs to be parsed; and obtain a cross-field flag bit indicating whether a parsing of a header needs to be carried out cross data segments.

The preset stage information table is generated by receiving message parsing configuration information of a user, and the message parsing configuration information includes the header type that can be parsed in each stage, the header length corresponding to each header type, a header field corresponding to each header type, and a stage transition information table corresponding to each header field.

The header extraction unit is configured to extract the header based on the header length corresponding to the header type and the cross-field flag bit in a predetermination result when the predetermination result of the predetermination module indicates that the header type can be parsed, to obtain the header corresponding to the header type, the header field and key information corresponding to the header.

The next-stage information item extraction unit is configured to extract a header type and a header offset for a next stage included in the stage transition information table based on the header field obtained by the header extraction unit for the current stage in combination with the header field in the preset stage information table, and to determine the flag bit indicating whether the current parsing has been completed.

It should be noted that when the apparatus for the staged parsing of the message implements the method for the staged parsing of the message provided in the above embodiments, division of programming modules is only described for exemplary purpose. In actual applications, the above processing may be allocated to be completed by different programming modules according to needs, i.e., an internal structure of the apparatus for the staged parsing of the message may be divided into different programming modules, to complete all or some of the above described processing. Moreover, the apparatus provided by the foregoing embodiments is proposed based on the same concept as the corresponding method embodiment, the specific implementation process may be understood with reference to the method embodiments, and the details will not be elaborated herein again.

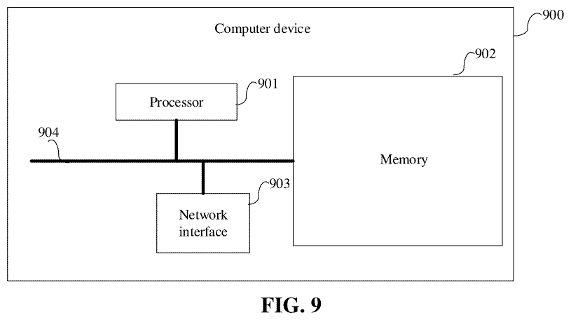

FIG. 9 is a schematic structure diagram of a computer device provided in an embodiment of the disclosure. As illustrated in FIG. 9, the computer device 900 includes a processor 901 and a memory 902 for storing a computer program capable of running by the processor. The processor 901 is configured to run the computer program to perform the following operations.

An n-th stage of parsing of a header in a message is performed based on parsing configuration information to obtain a parsing result in the n-th stage. When n is less than N, the parsing result in the n-th stage includes: header information parsed in the n-th stage, a header type of a next layer to be parsed in the message and an offset address for a next stage of parsing, N being a maximum number of parsing stages of the header.

An (n+1)-th stage of parsing of the header is skipped and an (n+2)-th stage of parsing is proceeded to when the header type of the next layer is not a header type to be parsed in the (n+1)-th stage.

The (n+1)-th stage of parsing of the header is performed based on the offset address when the header type of the next layer is the header type to be parsed in the (n+1)-th stage.

A staged parsing of the header is stopped when an N-th stage of parsing is completed or when a protocol parsing in an (N−1)-th layer determines that the N-th stage of parsing is to be skipped.

In practice, the computer device 900 may also include at least one network interface 903. Various components in the computer device 900 are coupled with each other through a bus system 904. It is understood that the bus system 904 is used for connection and communication between these components. The bus system 904 includes a data bus as well as a power bus, a control bus and a status signal bus. However, for the sake of clarity, various buses are labeled as the bus system 904 in FIG. 9. There may be at least one processor 901. The network interface 903 is configured for wired or wireless communication between the computer device 900 and other devices.

The memory 902 in the embodiment of the disclosure is configured to store various types of data to support the operation of the computer device 900.

The method disclosed in the above embodiments of the disclosure may be applied to or implemented by the processor 901. The processor 901 may be an integrated circuit chip and has a signal processing capability. During implementation, the steps of the foregoing method may be implemented by using an integrated logic circuit in a hardware form in the processor 901 or by using instructions in a software form. The foregoing processor 901 may be a general purpose processor, a Digital Signal Processor (DSP), or another programmable logical device, discrete gate or transistor logical device, or discrete hardware component. The processor 901 may implement or perform methods, steps and logical block diagrams disclosed in the embodiments of the disclosure. The general purpose processor may be a microprocessor or any conventional processor and the like. Steps of the methods disclosed with reference to the embodiments of the disclosure may be directly executed and completed by means of a hardware decoding processor, or by using a combination of software modules and hardware in the decoding processor. The software module may be located in a storage medium, and the storage medium is located in the memory 902. The processor 901 reads information in the memory 902 and completes the steps in the foregoing methods in combination with hardware of the processor.

In an exemplary embodiment, the computer device 900 may be implemented by one or more application specific integrated circuits (ASICs), DSPs, programmable logic devices (PLDs), complex PLDs (CPLDs), field-programmable gate arrays (FPGAs), general purpose processors, controllers, micro controller units (MCUs), microprocessors, or other electronic components, for performing the foregoing methods.

Embodiments of the disclosure further provide a computer-readable storage medium having stored thereon a computer program. When the computer-readable storage medium is applied to the method for the staged parsing of the message, the computer program is executed by a processor to cause the processor to implement the following operations.

An n-th stage of parsing of a header in a message is performed based on parsing configuration information to obtain a parsing result in the n-th stage. When n is less than N, the parsing result in the n-th stage includes: header information parsed in the n-th stage, a header type of a next layer to be parsed in the message and an offset address for a next stage of parsing, N being a maximum number of parsing stages of the header.

An (n+1)-th stage of parsing of the header is skipped and an (n+2)-th stage of parsing is proceeded to when the header type of the next layer is not a header type to be parsed in the (n+1)-th stage.

The (n+1)-th stage of parsing of the header is performed based on the offset address when the header type of the next layer is the header type to be parsed in the (n+1)-th stage.

A staged parsing of the header is stopped when an N-th stage of parsing is completed or when a protocol parsing in an (N−1)-th layer determines that the N-th stage of parsing is to be skipped.

In the several embodiments provided in the disclosure, it should be understood that the disclosed apparatus and method may be implemented in other ways. The device embodiment described above is merely exemplary. For example, the division of units is merely a logical function division and there may be other divisions in an actual implementation. For example, a plurality of units or components may be combined or integrated into another system, or some features may be ignored or not performed. In addition, the displayed or discussed couplings, direct couplings or communication connections between various components may be indirect couplings or communication connections implemented through some interfaces, apparatuses or units, and may be implemented in electrical, mechanical or other forms.

The units described as separate parts may or may not be physically separate, and parts displayed as units may or may not be physical units, they may be located in one position, or may be distributed on a plurality of network units. Some or all of the units may be selected according to actual needs to achieve the purpose of the solution in the embodiments.

In addition, functional units in the embodiments of the disclosure may be integrated into one processing unit, or each of the units may exist as an individual unit, or two or more units may be integrated into one unit. The integrated units may be implemented in the form of hardware, or may be implemented in the form of hardware combined with software functional units.

A person of ordinary skill in the art will understand that all or part of the steps for implementing the above-mentioned method embodiments can be completed by a program instruction-related hardware. The program can be stored in a computer-readable storage medium, and when the program is executed, the operations including the above-mentioned method embodiments are executed. The aforementioned storage medium includes a removable storage device, a read-only memory (ROM), a random access memory (RAM), a magnetic disk or an optical disk, and various media that can store program codes.

Alternatively, the integrated units of the disclosure may be stored in a computer-readable storage medium when they are implemented in form of a software functional module and sold or used as an independent product. Based on such understanding, the technical solutions of the disclosure essentially, or the part contributing to the prior art may be embodied in the form of a software product. The computer software product is stored in a storage medium, and includes several instructions for instructing a computer device (which may be a personal computer, a server, a network device, and the like) to perform all or part of the methods described in the embodiments of the disclosure. The foregoing storage medium includes any medium that can store program codes, such as a removable storage device, a ROM, a ROM, a magnetic disk, or an optical disk.

It should be noted that the term such as “first”, “second”, etc. is used to distinguish similar objects, and does not have to be used to describe a specific order or precedence.

In addition, the technical solutions described in the embodiments of the disclosure may be combined in any way if there is no conflict.

The foregoing descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure shall be subject to the scope of protection of the claims.

1. A method for a staged parsing of a message, wherein a message to be parsed comprises a header, and the method comprises:
performing, based on parsing configuration information, an n-th stage of parsing of the header to obtain a parsing result in the n-th stage, wherein when n is less than N, the parsing result in the n-th stage comprises: header information parsed in the n-th stage, a header type of a next layer to be parsed in the message and an offset address for a next stage of parsing, N being a maximum number of parsing stages of the header;
skipping an (n+1)-th stage of parsing of the header and proceeding to an (n+2)-th stage of parsing when the header type of the next layer is not a header type to be parsed in the (n+1)-th stage;
performing the (n+1)-th stage of parsing of the header based on the offset address when the header type of the next layer is the header type to be parsed in the (n+1)-th stage; and
stopping a staged parsing of the header when an N-th stage of parsing is completed or when a protocol parsing in an (N−1)-th layer determines that the N-th stage of parsing is to be skipped.

2. The method of claim 1, wherein the parsing configuration information comprises field parsing information and stage transition information; and
performing, based on the parsing configuration information, the n-th stage of parsing of the header to obtain the parsing result in the n-th stage comprises:
parsing a header field in the header based on the field parsing information for the n-th stage and a header type to be parsed in the n-th stage, wherein the header field comprises: a frame type, a header length, a header number and/or a mask; and
querying the stage transition information for the n-th stage based on the header field, to determine the header type of the next layer to be parsed and the offset address for the next stage of parsing.

3. The method of claim 2, wherein performing the (n+1)-th stage of parsing of the header based on the offset address comprises:
matching the header field to be parsed in the header with a header field table for the (n+1)-th stage when perform the (n+1)-th stage of parsing; and
parsing a content of the header field to be parsed in the header when the header field to be parsed in the header is a valid field contained in the header field table for the (n+1)-th stage.

4. The method of claim 3, further comprising:
stopping the (n+1)-th stage of parsing when the header field to be parsed in the header is an invalid field that is not contained in the header field table for the (n+1)-th stage.

5. The method of claim 1, further comprising:
segmenting a received data packet into a plurality of data segments based on a preset length when the received data packet is larger than a message length that can be processed by the staged parsing;
starting the staged parsing of the header from a first data segment in the plurality of data segments; and
concatenating parsing results of the staged parsing of the plurality of data segments to obtain a parsing result of the header.

6. The method of claim 5, wherein performing the (n+1)-th stage of parsing of the header based on the offset address when the header type of the next layer is the header type to be parsed in the (n+1)-th stage comprises:
when performing the (n+1)-th stage of parsing on a current data segment, in response to determining that a field to be parsed is partially located in a next data segment based on the offset address for the next stage of parsing, a header length corresponding to the header type of the next layer and a parsing length indicated by the field parsing information for the (n+1)-th stage, performing the (n+1)-th stage of parsing based on the current data segment in combination with the next data segment.

7. The method of claim 6, wherein performing the (n+1)-th stage of parsing based on the current data segment in combination with the next data segment comprises:
performing the (n+1)-th stage of parsing on the current data segment based on the offset address to obtain a first field part indicating a parsing result in the (n+1)-th stage, and determining that the (n+1)-th stage of parsing has not been completed;
continuing the (n+1)-th stage of parsing on the next data segment based on a length of the first field part and the header length corresponding to the header type of the next layer after the parsing of the next data segment proceeds to the (n+1)-th stage in which the parsing has not been completed, to obtain a second field part indicating the parsing result in the (n+1)-th stage; and
concatenating the second field part behind the first field part to obtain the parsing result in the (n+1)-th stage.

8. The method of claim 5, wherein performing the (n+1)-th stage of parsing of the header based on the offset address when the header type of the next layer is the header type to be parsed in the (n+1)-th stage comprises:
when performing the (n+1)-th stage of parsing on a current data segment, in response to determining that a field to be parsed is entirely located in the current data segment based on the offset address for the next stage of parsing, a header length corresponding to the header type of the next layer and a parsing length indicated by the field parsing information for the (n+1)-th stage, performing the (n+1)-th stage of parsing on the current data segment to obtain a parsing result in the (n+1)-th stage.

9. An apparatus for a staged parsing of a message, wherein a message to be parsed comprises a header, and the apparatus comprises:
a memory for storing a computer program; and
a processor;
wherein the processor is configured to execute the computer program stored in the memory to:
perform, based on parsing configuration information, an n-th stage of parsing of the header to obtain a parsing result in the n-th stage, wherein when n is less than N, the parsing result in the n-th stage comprises: header information parsed in the n-th stage, a header type of a next layer to be parsed in the message and an offset address for a next stage of parsing, N being a maximum number of parsing stages of the header;
skip an (n+1)-th stage of parsing of the header and proceed to an (n+2)-th stage of parsing when the header type of the next layer is not a header type to be parsed in the (n+1)-th stage;
perform the (n+1)-th stage of parsing of the header based on the offset address when the header type of the next layer is the header type to be parsed in the (n+1)-th stage; and
stop a staged parsing of the header when an N-th stage of parsing is completed or when a protocol parsing in an (N−1)-th layer determines that the N-th stage of parsing is to be skipped.

10. (canceled)

11. A non-transitory computer-readable storage medium having stored thereon a computer program that, when being executed by a processor, causes the processor to perform operations comprising:
performing, based on parsing configuration information, an n-th stage of parsing of a header to obtain a parsing result in the n-th stage, wherein when n is less than N, the parsing result in the n-th stage comprises: header information parsed in the n-th stage, a header type of a next layer to be parsed in a message and an offset address for a next stage of parsing, N being a maximum number of parsing stages of the header;
skipping an (n+1)-th stage of parsing of the header and proceeding to an (n+2)-th stage of parsing when the header type of the next layer is not a header type to be parsed in the (n+1)-th stage;
performing the (n+1)-th stage of parsing of the header based on the offset address when the header type of the next layer is the header type to be parsed in the (n+1)-th stage; and
stopping a staged parsing of the header when an N-th stage of parsing is completed or when a protocol parsing in an (N−1)-th layer determines that the N-th stage of parsing is to be skipped.

12. The apparatus of claim 9, wherein the parsing configuration information comprises field parsing information and stage transition information, and the processor is further configured to:
parse a header field in the header based on the field parsing information for the n-th stage and a header type to be parsed in the n-th stage, wherein the header field comprises: a frame type, a header length, a header number and/or a mask; and
query the stage transition information for the n-th stage based on the header field, to determine the header type of the next layer to be parsed and the offset address for the next stage of parsing.

13. The apparatus of claim 12, wherein the processor is further configured to:
match the header field to be parsed in the header with a header field table for the (n+1)-th stage when perform the (n+1)-th stage of parsing; and
parse a content of the header field to be parsed in the header when the header field to be parsed in the header is a valid field contained in the header field table for the (n+1)-th stage.

14. The apparatus of claim 13, wherein the processor is further configured to:
stop the (n+1)-th stage of parsing when the header field to be parsed in the header is an invalid field that is not contained in the header field table for the (n+1)-th stage.

15. The apparatus of claim 9, wherein the processor is further configured to:
segment a received data packet into a plurality of data segments based on a preset length when the received data packet is larger than a message length that can be processed by the staged parsing;
start the staged parsing of the header from a first data segment in the plurality of data segments; and
concatenate parsing results of the staged parsing of the plurality of data segments to obtain a parsing result of the header.

16. The apparatus of claim 15, wherein the processor is further configured to:
when performing the (n+1)-th stage of parsing on a current data segment, in response to determining that a field to be parsed is partially located in a next data segment based on the offset address for the next stage of parsing, a header length corresponding to the header type of the next layer and a parsing length indicated by the field parsing information for the (n+1)-th stage, perform the (n+1)-th stage of parsing based on the current data segment in combination with the next data segment.

17. The apparatus of claim 16, wherein the processor is further configured to:
perform the (n+1)-th stage of parsing on the current data segment based on the offset address to obtain a first field part indicating a parsing result in the (n+1)-th stage, and determining that the (n+1)-th stage of parsing has not been completed;
continue the (n+1)-th stage of parsing on the next data segment based on a length of the first field part and the header length corresponding to the header type of the next layer after the parsing of the next data segment proceeds to the (n+1)-th stage in which the parsing has not been completed, to obtain a second field part indicating the parsing result in the (n+1)-th stage; and
concatenate the second field part behind the first field part to obtain the parsing result in the (n+1)-th stage.

18. The apparatus of claim 15, wherein the processor is further configured to:
when performing the (n+1)-th stage of parsing on a current data segment, in response to determining that a field to be parsed is entirely located in the current data segment based on the offset address for the next stage of parsing, a header length corresponding to the header type of the next layer and a parsing length indicated by the field parsing information for the (n+1)-th stage, perform the (n+1)-th stage of parsing on the current data segment to obtain a parsing result in the (n+1)-th stage.

19. The non-transitory computer-readable storage medium of claim 11, wherein the parsing configuration information comprises field parsing information and stage transition information; and
performing, based on the parsing configuration information, the n-th stage of parsing of the header to obtain the parsing result in the n-th stage comprises:
parsing a header field in the header based on the field parsing information for the n-th stage and a header type to be parsed in the n-th stage, wherein the header field comprises: a frame type, a header length, a header number and/or a mask; and
querying the stage transition information for the n-th stage based on the header field, to determine the header type of the next layer to be parsed and the offset address for the next stage of parsing.

20. The non-transitory computer-readable storage medium of claim 19, wherein performing the (n+1)-th stage of parsing of the header based on the offset address comprises:
matching the header field to be parsed in the header with a header field table for the (n+1)-th stage when perform the (n+1)-th stage of parsing; and
parsing a content of the header field to be parsed in the header when the header field to be parsed in the header is a valid field contained in the header field table for the (n+1)-th stage.

21. The non-transitory computer-readable storage medium of claim 20, wherein the operations further comprise:
stopping the (n+1)-th stage of parsing when the header field to be parsed in the header is an invalid field that is not contained in the header field table for the (n+1)-th stage.
